(19) United States
(12) Patent Application Publication
(10) Pub. No.: US 2023/0281682 A1
(43) Pub. Date: Sep. 7, 2023

(54) INFRASTRUCTURE MANAGEMENT AGENT MANAGING PARAMETERS CORRESPONDING TO CLOUD-BASED COMPUTATIONAL SERVICES

(71) Applicant: Hewlett Packard Enterprise Development LP, Houston, TX (US)

(72) Inventors: Dejan S. Milojicic, Palo Alto, CA (US); Kenneth Leach, Houston, TX (US); Max Alt, San Jose, CA (US)

(21) Appl. No.: 17/688,134

(22) Filed: Mar. 7, 2022

(51) Int. Cl. G06Q 30/04; G06Q 30/02

(52) U.S. Cl. CPC G06Q 30/04; G06Q 30/0215

(57) ABSTRACT

Examples related to providing cloud-based computational services to a requesting entity having an infrastructure management agent. Revenue accounting corresponding to a first time period is performed for computational services utilized by the requesting entity. If revenue has changed over the first period of time beyond a pre-selected threshold amount, the infrastructure management agent adjusts quality of service (QoS) parameters or modifies billing discounts for the cloud-based computational services.

### BACKGROUND

Cloud computing may involve on-demand access to computer resources, such as computing and storage resources. Consumers may pay for cloud computing according to different models. In an example, cloud computing resource allocation and associated billing may be based on a range of fixed size of virtual machine (VM) instances.

### BRIEF DESCRIPTION OF THE DRAWINGS

FIG. 1 is a conceptual diagram of an infrastructure that provides services supporting an example billing mechanism.

FIG. 2 depicts an example chain of services utilized by an end user where service performance information is captured and shared within service signatures.

FIG. 3 illustrates example quality of service (QoS) adjustments based on revenue and billing fluctuations.

FIG. 4 depicts an example infrastructure that supports both discount-focused and QoS-focused service chains with multiple end users.

FIG. 5 depicts an example infrastructure that supports dynamically installable billing modules based on customer and/or provider preferences.

FIG. 6 is a flow diagram of an example technique for providing services supporting a billing mechanism to support cloud-based service management.

FIG. 7 is a block diagram of an example of a processing system for providing cloud-based services.

### DETAILED DESCRIPTION

Cloud infrastructure providers may provide infrastructure access and/or support in fixed-sized instances of virtual machines (VMs), physical instances, or other fixed-size units of infrastructure. A user may access the cloud-based infrastructure via a network of the Internet. Pricing for the access/support is based on the number and size of instances utilized. Each of these elements can fluctuate over time, but typically changes are modifications to the sizes of the fixed-size instances and the corresponding price structure.

However, with increased adoption of, for example, private clouds, introduction of new or different as a service (aaS) offerings (e.g., High Performance Compute aaS, or HPCaaS), and emergence of artificial intelligence (AI) and heterogeneous accelerators, this fixed-size model may be insufficient. Because of the granularity of resources allocated (e.g., fine-grained, large scale allocations, including heterogeneous resources composed on demand), the margin for cloud infrastructure management and pricing error is smaller and the impact of inefficient allocation and/or billing can be higher. Thus, more sophisticated cloud management systems would be beneficial.

In the examples that follow a customizable management and corresponding pricing structure are described that provide a flexible infrastructure environment with corresponding revenue-proportional billing mechanisms. In one example, the pricing mechanisms can result in a discounted price that is inversely proportional to the speed of revenue generation for infrastructure providers from entities utilizing the infrastructure. Automated infrastructure mechanisms can provide a dynamically modifiable infrastructure environment (e.g., variable instance size, variable instance types, variable number of instances, flexible instance topology) with corresponding continuous revenue proportional billing. In alternate or additional configurations, a different billing approach (e.g., alternative non-linear structure, step-wise structure) can also be supported.

Examples described herein are provided in terms of example infrastructures and configurations. However, the described examples may be generally applicable to different supply chains of compute cycle providers and consumers/users. As a further example, discounts that are offered and/or acquired by a provider (or an end user) from another provider can be managed together.

In some examples described below, service past performance (e.g., revenue generated, efficiency, discounts received, discounts passed) can be encoded into deployed service signatures to simplify infrastructure management and corresponding billing mechanisms. This encoded information can be adjusted periodically and/or aggregated periodically and utilized to drive policies through infrastructure or service management mechanisms. The encoded information can also be utilized to provide statistical information to (or about) corresponding users/customers.

In some examples, constant billing/pricing information along with exposed quality of service (QoS) controls can provide infrastructure users or providers the ability to trade QoS parameter adjustments for pricing adjustments/considerations, which allows for greater control over the infrastructure experience. QoS generally refers to levels of performance, reliability, security level and/or availability offered. Thus, QoS parameters are control elements and/or adjustments to various characteristics that result in changes to performance, reliability, security level and/or availability provided to the user. For example, as described in greater detail below, a user can maintain constant billing through revenue fluctuations by adjusting QoS parameters. Alternatively, the user can maintain billing within an acceptable range by making smaller adjustments to QoS parameters in times of revenue fluctuation.

In some examples, various different dynamically installable modules (e.g., plugins) can be utilized based on user preference to support the desired infrastructure experience. In one example, a custom dynamically installable billing plugin may be utilized to manage some of the features described herein. For example, a provider can either allow or disallow discounts. If allowed, the discounts can be, for example, proportional to the rate of revenue generation, or the discount can have accelerated growth (e.g., linear, or within brackets). In some examples, the user can utilize the plugin to, for example, trade future revenue for current discounted price and/or QoS.

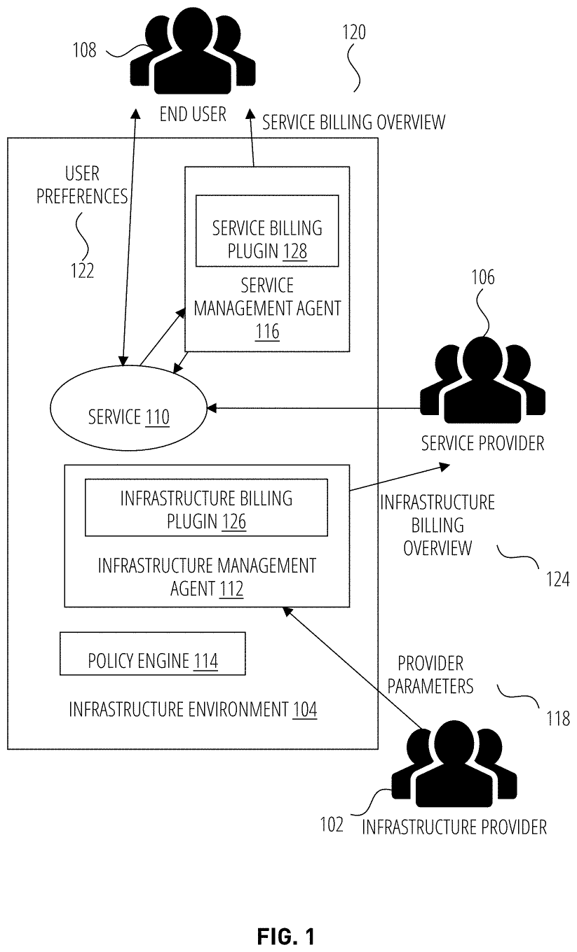

FIG. 1 is a conceptual diagram of an infrastructure that provides services supporting an example billing mechanism. The example of FIG. 1 illustrates a single service, a single service provider and a single end user; however, any number of services, service providers and end users can be supported.

In the example of FIG. 1, infrastructure provider 102 represents one or more entities that provide infrastructure environment 104, for example, entities that provide hardware processors, memory, graphics processing units and storage devices to support one or more services provided by infrastructure environment 104. Utilizing the functionality of infrastructure environment 104, one or more service providers (e.g., service provider 106) can provide cloud services, for example, cloud applications (e.g., SaaS) or application packages. End user 108 represents one or more users that utilize services available from infrastructure environment 104 via remote device (i.e., over a network connection to infrastructure environment 104). As described in greater detail below, each entity (e.g., end user 108, service provider 106, infrastructure provider 102) can be provided information and/or can provide preferences or parameters to manage the functionality of services and corresponding billing for the services.

In the example of FIG. 1, infrastructure environment 104 can provide services (e.g., service 110) to any number of end users (e.g., end user 108). Service 110 can be any type of cloud-based service (e.g., cloud storage, computing resources) that can be provided by hardware, software or a combination thereof. Infrastructure environment 104 can be, for example, a public cloud environment that operates on servers managed and maintained by infrastructure provider 102. Infrastructure environment 104 can provide, for example, software as a service (SaaS), platform as a service (PaaS), infrastructure as a service (IaaS), etc. Infrastructure environment 104 includes platforms, hardware, software and combinations thereof to provide one or more services (e.g., service 110) and supporting management functionality (e.g., infrastructure management agent 112, 114, service management agent 116).

SaaS generally refers to an architecture and model in which licensing and software functionality services are delivered based on a subscription-type arrangement where the components providing the services are hosted to provide an “on-demand” software arrangement. Similarly, PaaS generally refers to a cloud based environment in which a customer (e.g., end user, organization) can provision, instantiate and manage a platform having one or more applications without the requirement of building and maintaining the supporting infrastructure. IaaS generally refers to a cloud orchestration arrangement in which virtual machines (VMs) and corresponding support components (e.g., storage, firewalls) can be configured by a customer and utilized in an on-demand fashion. When infrastructure environment 104 provides multiple services, each service can have an associated service billing agent (the functionality of which is described in greater detail below).

In the examples that follow, one or more users (e.g., end user 108) can access one or more cloud-based computational services (e.g., service 110) provided by an infrastructure environment (e.g., infrastructure environment 104). The services provided by the infrastructure environment can be any type of on-demand services. Thus, the infrastructure environment can be an SaaS environment, a PaaS environment, an IaaS environment and the services provided can be software application services, platform services, or infrastructure services, respectively.

Infrastructure provider 102 can send provider parameters 118 to infrastructure management agent 112. In one example, the provider parameters 118 can include whether a discount is offered (e.g., yes or no), a discount value (e.g., as a percentage), a discount type (e.g., non-linear, linear, accelerating), QoS adjustments, etc. Infrastructure management agent 112 can utilize the provider parameters 118 and infrastructure environment 104 utilization to generate service billing overview 120 to service provider 106. Service billing overview 120 can provide, for example, billing structure information, resource usage information, billing discount information, etc. Infrastructure management agent 112 can be provided as hardware or a combination of hardware and software.

As one example, the following equations can be utilized to support revenue-proportional billing (RpB) for infrastructure utilization. In this example, a billing discount offered to end user 108 can be based on profit and the rate of change of revenue from end user 108 for using the infrastructure. For example:

$${Price}_{infra} = {γ}_{{profit}_{infra}} \times f ( {Service}_{resource \_ usage} , {Revenue}_{{infra}_{aggregate}} , {QoS}_{service} )$$

Thus, in one example, the price associated with an infrastructure can be a function of service resource usage, aggregate infrastructure revenue and QoS associated with a service scaled by an infrastructure profit factor. In one example, the aggregate infrastructure revenue over a period of time can be described by:

$${Revenue}_{{infra}_{aggregate}} = {\sum }_{t = 0}^{t = N} {Revenue}_{{infra}_{time = t}}$$

where:

$${Revenue}_{{infra}_{time = t}} = {Price}_{{infra}_{time = t}} \times {ResourceUsage}_{time = t} \times QoS$$

In one example, aggregate cost over a period of time can be described by:

$${Cost}_{{infra}_{aggregate}} = {\sum }_{t = 0}^{t = N} {Cost}_{{infra}_{time = t}}$$

where:

$${Cost}_{{infra}_{time = t}} = {ResourceUsage}_{time = t} \times ResourceType$$

In one example, profit can be described as:

$${γ}_{{profit}_{infra}} \sim {Revenue}_{{infra}_{aggregate}} - {Cost}_{{infra}_{aggregate}}$$

In one example, an infrastructure discount can be described as:

$${Discount}_{infra} \sim {γ}_{{profit}_{infra}} \times \frac{d ( {Revenue}_{{infra}_{aggregate}} )}{dt}$$

where revenue is based on resource usage, a price for the resource usage and QoS parameters, or some combination thereof and infrastructure profit (γ_{infra}) is based on aggregated infrastructure revenue and aggregated infrastructure costs. In one example, the infrastructure-level discount information can be determined based on revenue, usage and/or other factors for a first period of time, and then subsequently, the same or similar process can be utilized to determine a discount corresponding to a second period of time. In an example, the discount can be applied (or offered) after the revenue exceeds a threshold amount during the first period of time and/or after the rate of revenue exceeds a threshold amount during the first period of time. In an example, the discounted price can be inversely proportional to the rate of revenue growth of the first time period. The equations above provide one example technique for generating a discount to be offered, but other discount structures can be supported.

In this example infrastructure pricing equation, profit may be periodically calculated offline (e.g., by infrastructure management agent 112 and/or service management agent 116) and may be applied to discounts as a multiplier. Any number of other infrastructure pricing equations can be utilized in the architecture of FIG. 1. In the examples that follow, discounts offered to end user 108 can be based on the equation above (or some alternative) and adjusted based on user preferences 122 and other factors to provide an improved

Service provider 106 can utilize infrastructure billing overview 124 from infrastructure management agent 112 to adjust infrastructure environment 104 utilization in providing service 110, if desired. Infrastructure billing overview 124 can include billing information including, for example, pricing for current usage levels, discounts applied, discounts available, etc. Service provider 106 can, for example, manage QoS parameters and discounts offered based on infrastructure billing overview 124 from infrastructure management agent 112. For example, service provider 106 can, based on information in infrastructure billing overview 124 determine that a discount structure being offered is not competitive and make appropriate adjustments for future billing cycles. In some examples, adjustments to service 110 (e.g., QoS parameters) can be automated via use of infrastructure billing plugin 126.

Service 110 may comprise resources of infrastructure environment 104 and may be provided to end user 108 as well as any number of other end users. In one example, end user 108 provides service 110 or service management agent 116 one or more user preferences 122 that can be utilized for managing use of services and corresponding billing. In one example user preferences 122 can include, for example, billing preferences. Service management agent 116 can be provided as hardware or a combination of hardware and software. In some examples, service management agent 116 can support RpB based on the following equations where price of a given service 110 can be described as:

$${Price}_{{service}_{N - 1}} = {γ}_{{profit}_{{service}_{N - 1}}} \times f ( {Service}_{{N}_{usage}} , {Revenue}_{{service}_{N - {1}_{aggregate}}} , {QoS}_{{service}_{N}} )$$

Thus, in one example, the price associated with an individual service can be a function of service resource usage, aggregate service revenue and QoS associated with a service scaled by a service profit factor.

In one example, aggregate service revenue can be described by:

$${Revenue}_{serviceN - {1}_{aggregate}} = {\sum }_{t = 0}^{t = N} {Revenue}_{serviceN - {1}_{time = t}}$$

where:

$${Revenue}_{serviceN - {1}_{time = t}} = {Price}_{{serviceN}_{time = t}} \times {Service}_{N - 1 {usage}_{time = t}}$$

In one example, aggregate service cost over a time period can be determined by:

$${Cost}_{serviceN - {1}_{aggregate}} = {\sum }_{t = 0}^{t = N} {Cost}_{serviceN - {1}_{time = t}}$$

where:

$${Cost}_{serviceN - {1}_{time = t}} = {Service}_{N - 1 {usage}_{time = t}} \times {Service}_{QoS}$$

Further, service profit of the service can be described as approximately the revenue minus the cost:

$${γ}_{serviceN - 1} \sim {Revenue}_{serviceN - {1}_{aggregate}} - {Cost}_{serviceN - {1}_{aggregate}}$$

In one example, a service level discount can be described as:

$${Discount}_{serviceN - 1} \sim {γ}_{{profit}_{serviceN - 1}} \times \frac{d ( {Revenue}_{serviceN - {1}_{aggregate}} )}{dt}$$

Thus, the service level discount can be based on the rate of change in service revenue over time.

Any number of other service pricing equations can be utilized in the architecture of FIG. 1. In other examples user preferences 122 can include additional and/or different preferences, for example, futures billing preferences, QoS modification preferences, etc. In one example, the service-level discount information can be determined based on revenue, usage and/or other factors for a first period of time, and then subsequently, the same or similar process can be utilized to determine a discount corresponding to a second period of time. In an example, the discount can be applied (or offered) after the revenue exceeds a threshold amount during the first period of time and/or after the rate of revenue exceeds a threshold amount during the first period of time. In an example, the discount can be inversely proportional to the rate of revenue growth of the first period.

End user 108 can utilize information from service billing overview 120 received from service management agent 116 to adjust service 110, if desired. End user 108 can also manage QoS parameters and discounts offered based on service billing overview 120 from service management agent 116. In some examples, adjustments to utilization of service 110 can be automated via use of service billing plugin 128.

Multiple different dynamically installable billing modules (e.g., service billing plugin 128, infrastructure billing plugin 126) can be supported. In various examples, the billing plugin functionality can be based on one or more of user preferences 122, provider parameters 118. In some examples, infrastructure provider 102 and/or service provider 106 can either allow or disallow discounts. In an example, if discounts are allowed, the discounted price can be inversely proportional to the speed of revenue generation. In an example, the discount amount can have an accelerated growth profile (either linear or within bracketed ranges) where discounts increase over time and/or in response to increased revenue generation. Further, end user 108 can trade future revenue for discounted pricing and/or QoS.

One example approach to allowing plugins is to support user pluggable policies that execute on provider resources (e.g., policy engine 114). The user pluggable policies implement specified policies based on user specifications within policy engine 114 or other components in infrastructure environment 104. A pluggable policy can be, for example, a file or other component that provides a description of a policy to be supported. Policies can include, for example, discount structures. As another example, a plugin can be a software component that provides/supports additional functionality. A plugin can be, for example, a software component to be executed by policy engine 114 or another component of infrastructure environment 104.

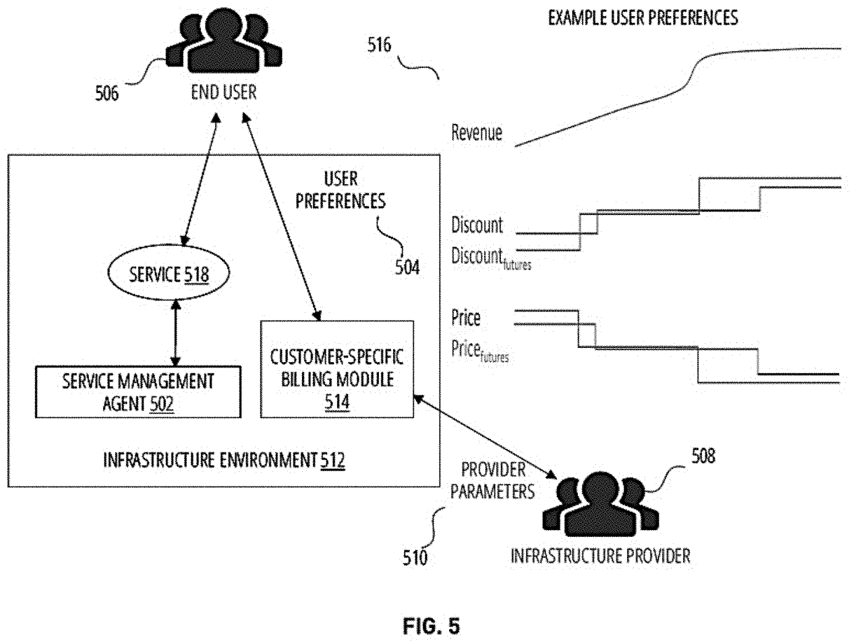

More detail related to a pluggable policy configuration is provided in the example described with respect to FIG. 5. For example, policy engine 114 can calculate various threshold values based on customer preferred functions (e.g., indicated by user preferences 122). Policy engine 114 can impose boundary conditions set by infrastructure provider 102 so that end user values can be weighted within ranges allowed by infrastructure provider 102. The functionality of policy engine 114 can be provided as hardware, software or a combination thereof.

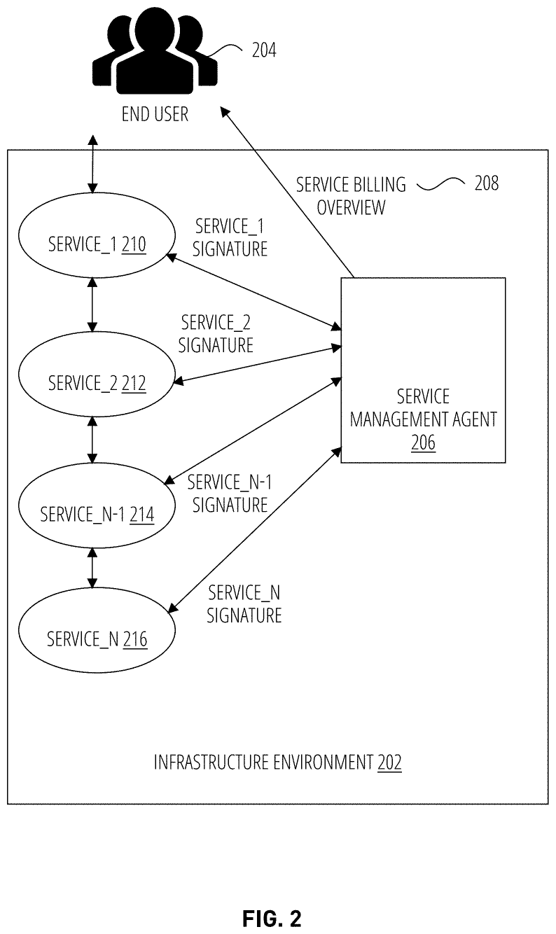

FIG. 2 depicts an example chain of services utilized by an end user where service performance information is captured and shared within service signatures. Service signatures can be, for example, metadata passed between services in infrastructure environment 202. In some examples, the service signatures can be cryptographically signed or otherwise secured. In various examples, the multiple services may provide a hierarchical service structure to provide end user 204 a desired set of services. Service management agent 206 provides service billing overview 208 information for the services utilized by end user 204.

In the example of FIG. 2, end user 204 may have configured a hierarchical structure of services within infrastructure environment 202. Any number of cloud-based computational services (e.g., service_1 210, service_2 212, service_n-1 214, service_n 216) can be supported. Each of the services communicates with service management agent 206 to provide the billing functionality described above. In one example, each service can provide to service management agent 206 performance and/or revenue information within, for example, a service signature (e.g., service_1 signature, service_2 signature, service_n-1 signature, service_n signature). Service management agent 206 can then provide service billing overview 208 to end user 204 that includes relevant information including pricing/billing information. In one example, the shared information can be provided in service signatures.

Service signatures can be used, for example, to provide performance information (e.g., revenue generated, service efficiency, discounts received, discounts passed) between one or more services (e.g., service_1 210, service_2 212, service_n-1 214, service_n 216) and service management agent 206. Information from the service signatures can be utilized to generate and/or update service billing overview 208.

In one example, the following service signatures can be utilized with the services illustrated in FIG. 2.
Service₁Signature (signed by Service₂): {Service₁, Revenue; Efficiency, Discount_{received,} Discount_{passed}}_{service_1provider,} {Service₂, Revenue; Efficiency, Discount_{received,} Discount_{passed}}_{service_2provider,} {Service_{N-1}, Revenue; Efficiency, Discount_{received,} Discount_{passed}}_{service_N-1provider,} {Service_{N}, Revenue; Efficiency, Discount_{received,} Discount_{passed}}_{service_Nprovider.}
Service₂Signature (signed by Service₃): {Service₂, Revenue; Efficiency, Discount_{received,} Discount_{passed}}_{service_2provider,} {Service₃, Revenue; Efficiency, Discount_{received,} Discount_{passed}}_{service_3provider,} {Service_{N-1}, Revenue; Efficiency, Discount_{received,} Discount_{passed}}_{service_N-1provider,} {Service_{N}, Revenue; Efficiency, Discount_{received,} Discount_{passed}}_{service_Nprovider.}
Service_{N-1}Signature (signed by Service_{N}): {Service_{N-1}, Revenue; Efficiency, Discount_{received,} Discount_{passed}}_{service_1provider,} {Service_{N}, Revenue; Efficiency, Discount_{received,} Discount_{passed}}_{service_Nprovider.}
Service_{N}Signature (signed by Infrastructure Provider): {Service_{N}, Revenue; Efficiency, Discount_{received,} Discount_{passed}}_{infrastructure_provider.}

The example of FIG. 2 may use a single set of user preferences for the chain of services utilized by end user 204. However, in more complex examples, multiple sets of user preferences to be utilized in various positions in the chain of services can be supported. For example, a first set of user preferences can be utilized for service_1 210 and service_2 212, while a second set of user preferences can be utilized for service_n-1 214 and service_n 216.

Similarly, multiple sets of provider parameters can be used in various positions in the chain of services. Service management agent 206 can function to manage this more complex example, or multiple service management agents can be supported. The provider parameters grouping may be different than the user preferences grouping. For example, service_1 210 may have a first set of provider parameters and service_2 212, service_n-1 214, and service_n 216 may have a second set of provider parameters.

In some examples having chained services, a revenue accounting can be performed at multiple locations in the chain (e.g., between each link in the chain, or for each service in the chain) to evaluate/determine the revenue generated through use of various components within infrastructure environment 202. In one example, the revenue accounting process can be performed for a first period of time, and then subsequently, the same or similar revenue accounting process can be performed for a second period of time.

The revenue accounting information combined with aggregated or accumulated information (e.g., resource demand), user preferences (e.g., user preferences 122 and provider parameters 118) can be utilized to manage discounts and/or QoS adjustments within the chain of services. In other examples, discount levels and QoS levels can be utilized for purchasing of (or negotiating for) bids to provide computational resources. Thus, conceptually, the mechanisms described herein can be used to support both a push (where information is provided, or pushed, from an outside entity, for example, provider parameters 118) approach and a pull (where information is requested by the service) approach to managing discounts, QoS, etc.

The example of FIG. 2 includes a single hierarchical services structure for a single end user; however, any number of hierarchical service structures for any number of end users can be supported. More complex examples are described below.

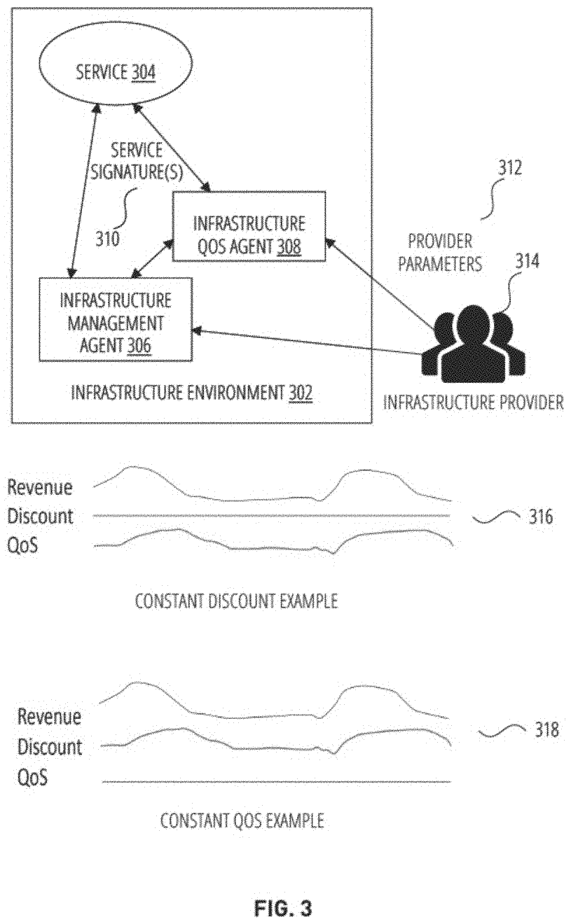

FIG. 3 illustrates example quality of service (QoS) adjustments based on revenue and billing fluctuations. Alternatively, a discount can be adjusted based on revenue and QoS fluctuations. The example of FIG. 3 provides exposed QoS controls to allow an end user (or other relevant entity) to, for example, maintain constant billing in the event of revenue fluctuations in an environment utilizing revenue-proportional billing (RpB). For example, pricing may be maintained at a constant (or near constant) level with QoS adjustments (e.g., adjustments to resource utilization, adjustments to resource requests). In some examples, policies for QoS adjustments to maintain pricing at a constant (or near constant) level can be propagated through chains of service invocations (such as the one illustrated in FIG. 2).

In the example of FIG. 3, infrastructure environment 302 can provide service 304 (and any number of additional cloud-based computational service instances, not illustrated in FIG. 3). Infrastructure environment 302 can further include infrastructure management agent 306 (which is analogous to infrastructure management agent 112) to provide management and billing functionality. Infrastructure environment 302 can also include infrastructure QoS agent 308, which can function to manage QoS parameters based on, for example, service signature(s) 310 from service 304, provider parameters 312 from infrastructure provider 314 and/or information obtained from infrastructure environment 302. An agent (e.g., infrastructure management agent 306, infrastructure QoS agent 308) can be implemented as hardware or a combination of hardware and software to provide the functionality of the agent as described.

In the example of FIG. 3, infrastructure management agent 306 and infrastructure QoS agent 308 can communicate to automatically maintain selected billing/pricing parameters within ranges specified by provider parameters 312 from infrastructure provider 314. The example of FIG. 3 illustrates constant discount example 316 and constant QoS example 318; however, other parameters can be managed in a similar manner. Infrastructure management agent 306 can provide infrastructure QoS agent 308 with service billing overview information that can allow infrastructure QoS agent 308 to make changes to how service 304 operates within infrastructure environment 302.

In constant discount example 316, infrastructure provider 314 desires a constant discount as revenue changes. Thus, infrastructure QoS agent 308 monitors revenue associated with service 304 and makes QoS parameter adjustments to maintain a constant discount, if possible. In a related example, infrastructure QoS agent 308 can make QoS parameter adjustments (e.g., adjustment to bandwidth usage, memory usage, security features) to maintain the discount within a specified range (e.g., +/−5% of the baseline discount).

Another separate example is illustrated as constant QoS example 318, infrastructure provider 314 desires a constant QoS environment as revenue changes. Thus, infrastructure QoS agent 308 can maintain constant QoS parameters and infrastructure management agent 306 can adjust available discounts in response to revenue changes to maintain constant QoS over an extended period of time. This can mean, for example, that infrastructure management agent 306 might delay utilization of a discount until a later time, for example, upon reaching a higher revenue level. In a related example, infrastructure management agent 306 can attempt to maintain the QoS within a specified range (e.g., +/−5% of the baseline).

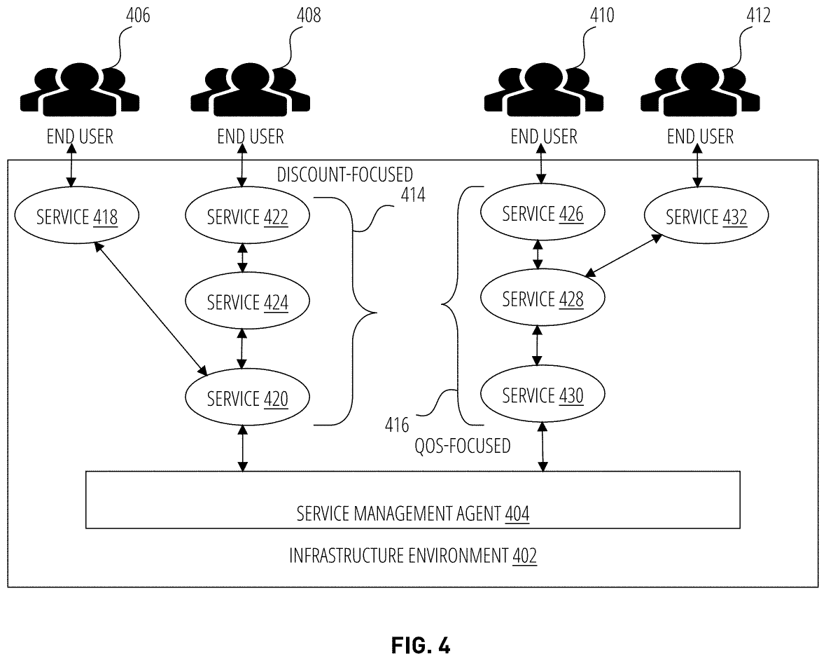

In the examples of FIG. 3, if an end user chooses to focus on discounts, increases in revenue can result in increased discounts and vice versa, but QoS can remain constant (or approximately constant). However, if the end user chooses to focus on QoS, discounts can be fixed and QoS can fluctuate subject to revenue fluctuations. As another example (not illustrated in FIG. 3), some combination of the illustrated options can be provided. For example, both discount and QoS can be allowed to fluctuate within pre-selected ranges with one having a greater weight than the other. Further, service 304 can be one service in a chain of services (e.g., service chains described in FIG. 2 and FIG. 4).

FIG. 4 depicts an example infrastructure that supports both discount-focused and QoS-focused service chains with multiple end users. In the example of FIG. 4, discount-focused and QoS-focused preferences by end users can be propagated down chains of services. In the example of FIG. 4, all services may execute on a single infrastructure environment. Services earlier in the chains may be more likely to use less infrastructure resources and services closer to the bottom of the chain may be more likely to use more infrastructure resources. In the example of FIG. 4, discount-focused end users and QoS-focused end users utilize different instances of services because different scheduling may be utilized for discount-focused services as compared to QoS-focused services.

In the example of FIG. 4, infrastructure environment 402 includes service management agent 404 (which may be analogous to service management agent 116 or service management agent 206) and can provide services to multiple end users (e.g., end users 406, 408, 410, 412). Two of the end users (end user 406 and end user 408) utilize discount-focused 414 mechanisms (e.g., analogous to FIG. 1 and FIG. 2) to achieve conditions analogous to constant discount example 316 and two of the end users (end user 410 and end user 412) utilize QoS-focused 416 mechanisms to achieve conditions analogous to constant QoS example 318.

End user 406 can utilize a chain of services including service 418 and service 420, while end user 408 can utilize a more complex chain of services including service 422, service 424 and service 420. Each of these service chains can be managed in the manner described in FIG. 2. Similarly, end user 410 can utilize a chain of services including service 426, service 428 and service 430, while end user 412 can utilize a chain of services including service 432, service 428 and service 430. These service chains can also be managed in the manner described in FIG. 2. Thus, a single infrastructure environment (e.g., infrastructure environment 402) and a single service management agent (e.g., service management agent 404) can support multiple end users with different service chains and/or different focuses (i.e., discount, QoS).

As described with respect to FIG. 2, the services provided by infrastructure environment 402 can support complex relationships between the various services provided with respect to corresponding user preferences and provider parameters.

FIG. 5 depicts an example infrastructure that supports dynamically installable billing modules based on customer and/or provider preferences. The example of FIG. 5 provides a customer-specific module (e.g., plugin or other file describing preferences) for service management agent 502. The customer-specific module can be used to implement policies based on user specifications within infrastructure environment 512. A customer-specific module can be, for example, a software component that can add functionality to implement the specified policies, a file or other component that provides a description of policies and/or billing structures to be supported. Policies can include, for example, discount structures. As another example, a customer-specific module can be a software component that provides/supports additional functionality.

In some examples, the customer-specific module could be used to establish user preferences 504 (e.g., corresponding to end user 506), such as charges that trade off future revenue for reduced initial pricing structures. In some examples, the customer-specific module can further include limitations provided by one or more infrastructure providers (e.g., infrastructure provider 508) through use of provider parameters (e.g., provider parameters 510).

In the example of FIG. 5, infrastructure environment 512 can support any number of customer-specific billing modules (e.g., customer-specific billing module 514) that can function according to user preferences 504 (e.g., from end user 506) and/or provider parameters 510 (e.g., from infrastructure provider 508). Example user preferences 516 provide a graphical representation of the type of information that can be communicated by user preferences 504 that can be utilized by customer-specific billing module 514.

Customer-specific billing module 514 may function to provide service management agent 502 with information to manage service 518 based on user preferences 504 and 510. Customer-specific billing module 514 can be, for example, customer-specific software component that adds functionality to service management agent 502. As another example, customer-specific billing module 514 can be a hardware or firmware component providing the specified billing functionality.

In the example of FIG. 5, infrastructure environment 512 can be, for example, a public cloud environment that operates on servers managed and maintained by infrastructure provider 508. Infrastructure environment 512 can provide any offering as a service, such as, for example, SaaS, PaaS, IaaS, etc. When infrastructure environment 512 provides multiple services (not illustrated in FIG. 5), each service can have an associated service billing agent.

In one example, customer-specific billing module 514 and/or service management agent 502 can function to determine revenue, usage and/or other factors for a first period of time, and then subsequently, the same or similar process can be utilized to determine a discount corresponding to a second period of time.

Service management agent 502 (which can be analogous to service management agent 116, service management agent 206, service management agent 404) can utilize provider parameters 510 and user preferences 504 along with monitoring of operation of service 518 to generate a service billing overview to end user 506. Customer-specific billing module 514 can provide an automated functionality to accomplish user preferences 504 through service management agent 502 and use of service 518. For example, user preferences 504 and/or customer-specific billing module 514 can specify thresholds beyond which a currently offered discount is delayed for future usage. Thus, the combined functionality of service management agent 502 and customer-specific billing module 514 can provide a more efficient and streamlined experience than would otherwise be possible.

Over time, end user 506 can modify example user preferences 516 and/or infrastructure provider 508 can modify provider parameters 510 to further refine the functionality of infrastructure environment 512 and/or service 518. The example of FIG. 5 illustrates only a single service, end user, service management agent, customer-specific billing module and infrastructure provider; however, in alternate examples, any number of services, end users, service management agents, customer-specific billing modules and infrastructure providers can be supported.

In the example of FIG. 5, infrastructure provider 508 can choose to allow or not allow discounts (e.g., via provider parameters 510). If discounts are allowed, the discount offered can be, for example, proportional to the rate of revenue generation, or the discount can correspond to accelerated growth (e.g., linear or within a bracketed range). End user 506 can trade off future revenue for currently discounted price and/or QoS (e.g., via the user preferences 504).

In one example, customer-specific billing module 514 can provide a set of user (e.g., end user 506) pluggable policies that are implemented by service management agent 502. These policies can function to execute (or enforce) preferences or functions specified by end user 506 (e.g., via the user preferences). In some situations, multiple user preferences can be supported. For example, customer-specific billing module 514 can determine various threshold values based on user preferences and service management agent 502 can enforce limits specified by provider parameters from infrastructure provider 508 so that values of user preferences 504 can be weighted within ranges allowed by infrastructure provider 508.

In another example, user preferences 504 can be provided and/or modified through use of metadata that is part of service requests to access service 518. In some examples, the metadata can function to enable and disable the functionality of customer-specific billing module 514. In other examples, the metadata can function to modify the functionality of customer-specific billing module 514 to, for example, adjust user preferences 504 based on service execution (e.g., from service 518).

As mentioned above, end user 506 can (e.g., via the user preferences) trade off future revenue for currently discounted pricing and/or QoS modifications. This can allow for higher discounts (as compared to the base discount structure) earlier in time in exchange for decreased discounts later in time (e.g., subsequent accounting periods). In an example, customer-specific billing module 514 can be utilized to negotiate the modified discount structure with infrastructure provider 508 by, for example, establishing an increased discount for the next set (e.g., 100, 250, 75) of service requests with a reduced discount on the following set (e.g., 100, 250, 75) of service requests (after service requests with increased discount were executed, assuming increased rate of revenue to qualify for the increased discount under the base discount structure).

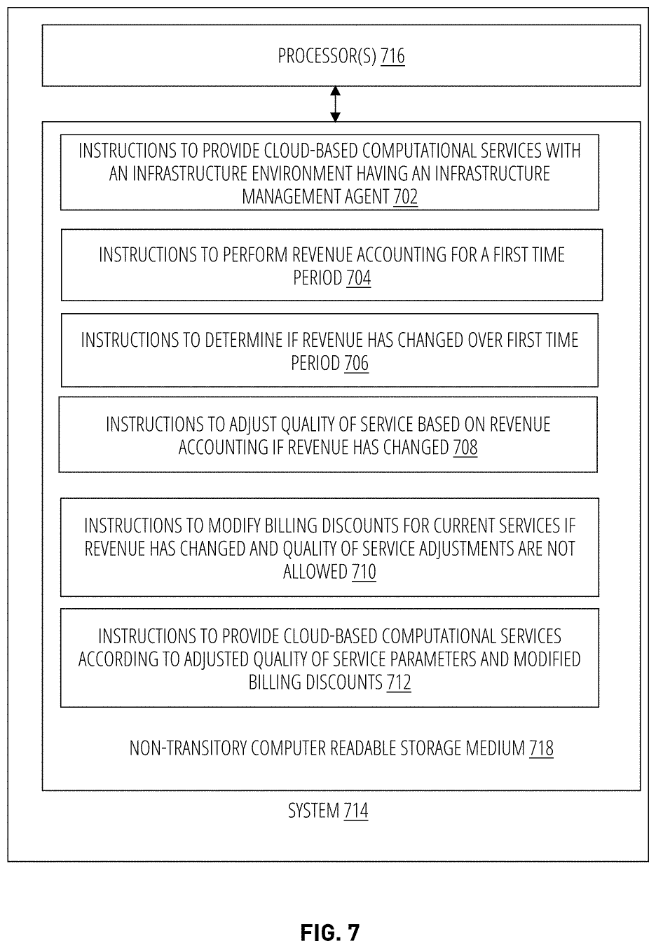

The specific examples of FIG. 5 are just a few of the types of preference, pricing and negotiation structures that can be supported utilizing the architectures of FIG. 1, FIG. 2, FIG. 3, FIG. 4, FIG. 5 and FIG. 7. Many other variations can be similarly supported.

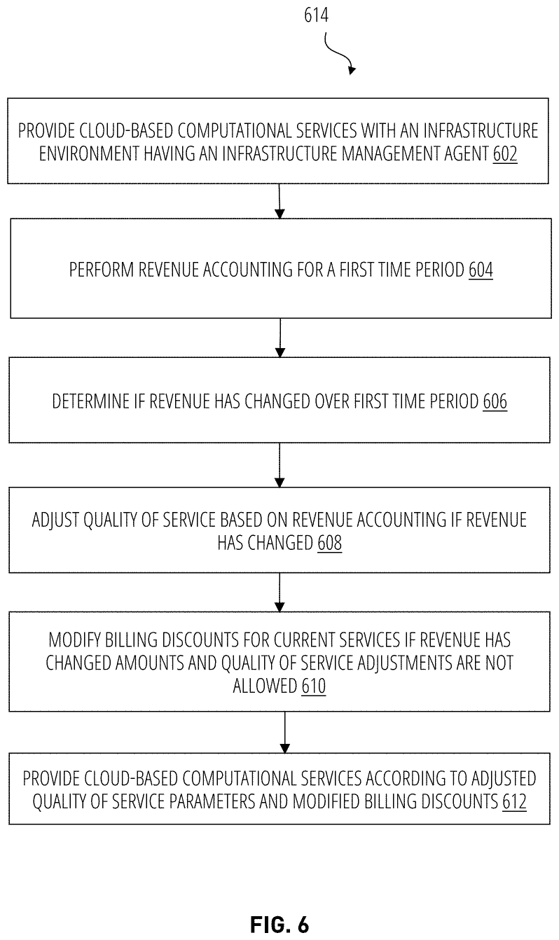

FIG. 6 is a flow diagram of an example technique for providing services supporting a billing mechanism to support cloud-based service management. Technique 614 can be provided or performed, for example, by hardware-based components such as those illustrated in, and described with respect to, FIG. 1, FIG. 2, FIG. 3, FIG. 4, FIG. 5 or FIG. 7.

In block 602, cloud-based computational services can be provided by an infrastructure environment having an infrastructure management agent. In one example, the cloud-based computational services can be provided by an infrastructure provider (e.g., infrastructure provider 102, infrastructure provider 314, infrastructure provider 508). In some examples, the infrastructure providers can utilize provider parameters or other configuration functionality to manage the cloud-based computational services provided by the infrastructure environment.

In block 604, revenue accounting is performed for a first time period. For example, a service management agent (e.g., service management agent 116, service management agent 206, service management agent 404, service management agent 502) can function to monitor one or more services provided by the infrastructure environment to one or more end users (or groups of users, organizations, etc.) to determine various revenue metrics for the first period of time. In one example, the revenue accounting can be used to determine a discount structure based on the speed of revenue generation ((d Revenue)/dt) by the services. In other examples, different revenue accounting approaches can be utilized.

In block 606, a service management agent can determine if revenue has changed over first time period beyond threshold amounts. For example, a service management agent (e.g., service management agent 116, service management agent 206, service management agent 404, service management agent 502) can determine if the monitored revenue amounts have changed beyond threshold amounts for the first time period. The threshold amounts can be set, for example, by the provider parameters, by the user preferences or some combination thereof. Use of threshold values can help manage the amount of overhead expended to manage various discount changes/negotiations and/or QoS parameter modifications.

In block 608, quality of service parameters can be adjusted based on revenue accounting if revenue has changed beyond threshold amounts (as determined in block 606). For example, a service management agent (e.g., service management agent 116, service management agent 206, service management agent 404, service management agent 502) and/or some other component within the corresponding infrastructure environment (e.g., infrastructure environment 104, infrastructure environment 202, infrastructure environment 302, infrastructure environment 402, infrastructure environment 512) can respond to revenue changes to adjust QoS parameters for one or more components involved in providing requested services (e.g., via service 110, service 304, service 418, service 518).

In one example, based on user preferences (e.g., user preferences 122, user preferences 504) and/or provider parameters (e.g., provider parameters 118, provider parameters 312, provider parameters 510), adjustments to QoS parameters may be within specified bounds. In another example, adjustments to QoS parameters may be selectively allowed or not allowed as specified, for example, in corresponding provider parameters (e.g., provider parameters 118, provider parameters 312, provider parameters 510). In an example, if QoS parameter adjustments are allowed, the adjustments may be made within specified bounds.

In block 610, billing discounts can be modified for current services if revenue has changed beyond the threshold amounts (as determined in block 606). In some examples, billing discounts are modified if quality of service adjustments are not allowed (e.g., block 608 is performed without adjusting QoS, due, for example, to user preferences or provider parameters specifying no allowance for QoS adjustments). For example, a service management agent (e.g., service management agent 116, service management agent 206, service management agent 404, service management agent 502) and/or other components of host infrastructure environment (e.g., infrastructure environment 104, infrastructure environment 202, infrastructure environment 302, infrastructure environment 402, infrastructure environment 512) can respond to revenue changes beyond the threshold amounts by adjusting billing discounts if QoS modifications are not allowed. In some examples, adjustments may be made to both QoS parameters and billing discounts.

The infrastructure provider (e.g., infrastructure provider 508) can provide ranges within which billing discounts can be provided (e.g., via the provider parameters). The discount offered can be, for example, proportional to the rate of revenue generation, or the discount can correspond to accelerated growth (e.g., linear or within a bracketed range). A user or other entity can use these offers for discounts to trade future revenue for currently discounted price and/or QoS (e.g., via the user preferences).

In block 612, cloud-based computational services are provided according to adjusted quality of service parameters (e.g., based on block 608) and/or modified billing discounts (e.g., based on block 610). Technique 614 can be repeated any number of times.

FIG. 7 is a block diagram of an example of a processing system for providing cloud-based services. In an example, system 714 can include processor(s) 716 and non-transitory computer readable storage medium 718. Non-transitory computer readable storage medium 718 may store instructions 702, 704, 706, 708 and 710 that, when executed by processor(s) 716, cause processor(s) 716 to perform various functions. Examples of processor(s) 716 may include a microcontroller, a microprocessor, a central processing unit (CPU), a graphics processing unit (GPU), a data processing unit (DPU), an application-specific integrated circuit (ASIC), a field-programmable gate array (FPGA), a system on a chip (SoC), etc. Examples of a non-transitory computer readable storage medium 718 include tangible media such as random-access memory (RAM), read-only memory (ROM), electrically-erasable read-only memory (EEPROM), flash memory, a hard disk drive, etc.

Instructions 702 cause processor(s) 716 to provide cloud-based computational services with an infrastructure environment (e.g., infrastructure environment 104, infrastructure environment 202, infrastructure environment 302, infrastructure environment 402, infrastructure environment 512) having an infrastructure management agent (e.g., infrastructure management agent 112, infrastructure management agent 306). Any number of processor(s) 716 can provide cloud-based services to one or more remote entities (e.g., end user 108, end user 204, end user 408, end user 506).

Instructions 704 cause processor(s) 716 to perform revenue accounting for a first time period. In one example, the revenue accounting can be based on the speed of revenue generation ((d Revenue)/dt). In other examples, different revenue accounting approaches can be utilized.

Instructions 706 can cause a service management agent (e.g., service management agent 116, service management agent 206, service management agent 404, service management agent 502) to determine if the monitored revenue amounts have changed over the first time period. Detected changes can be compared to, for example, provider parameters, by the infrastructure management agent (e.g., infrastructure management agent 112, infrastructure management agent 306) to determine whether adjustments should be made and/or notifications generated.

Instructions 708 can cause the service management agent to adjust quality of service based on revenue accounting if revenue has changed (as determined by instructions 706). Service management agents and/or other components of the infrastructure environment can respond to revenue changes by, for example, adjusting billing discounts based on, for example, provider parameters and/or user preferences. In some examples, adjustments may be made to both QoS parameters and billing discounts.

Instructions 710 can cause the service management agent to modify billing discounts for current services if revenue has changed beyond the threshold amounts (as determined by instructions 706). In an example, instructions 710 can be performed when quality of service adjustments are determined (e.g., when performing instructions 708) to be not allowed. Service management agents and/or other components of the infrastructure environment can respond to revenue changes by adjusting billing discounts based on, for example, provider parameters and/or user preferences. In some examples, adjustments may be made to both QoS parameters and billing discounts.

Instructions 712 can cause processor(s) 716 to provide cloud-based computational services according to adjusted quality of service parameters and modified billing discounts, if any. The processes provided by instructions 702, 704, 706, 708, 710 and 712 can be repeated.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 718 has stored thereon data representing sequences of instructions that, when executed by a processor(s) 716, cause the processor(s) 716 to perform certain operations.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. A system comprising:
a processor; and
a memory system storing instructions that, when executed by the processor, cause the processor to:
provide a set of cloud-based computational services utilizing a plurality of resources to a requesting entity, wherein the computational services are provided by an infrastructure environment having an infrastructure management agent to at least manage parameters corresponding to selected computational services,
perform a revenue accounting corresponding to a first time period for the requesting entity based on computational services utilized by the requesting entity,
adjust quality of service (QoS) parameters, with the infrastructure management agent, for the cloud-based computational services based on the revenue accounting if the revenue has changed over the first period of time,
modify billing discounts for current cloud-based computational services, with the infrastructure management agent, if the revenue has changed over the first period of time, and
provide the set of cloud-based computational services to the requesting entity according to the adjustment of the QoS parameters and according to the modified billing discounts over a second period of time.

2. The system of claim 1 wherein the instructions, when executed, cause the processor to modify future billing discounts for the cloud-based computational services, with the infrastructure management agent, if the revenue has changed over the first period of time, QoS adjustment is not allowed and modification of billing discounts for future cloud-based computational services is allowed.

3. The system of claim 1 wherein to modify billing discounts for the cloud-based computational services comprises causing the processor to modify resource billing where a discounted price is inversely proportional to a speed of revenue generation.

4. The system of claim 1 wherein QoS adjustment comprises at least modifications to one or more of: allowed throughput, allowed delay, security level, privacy level, priority level and resource availability.

5. The system of claim 1 wherein to determine if revenue has changed over the first period of time beyond pre-selected threshold amounts comprises causing the processor to:
determine a rate of revenue change over the first period of time;
compare the rate of revenue change to a pre-selected upper rate of change and to a pre-selected lower rate of change.

6. The system of claim 1 wherein the instructions, when executed, cause the processor to utilize provider parameters corresponding to the cloud-based computational services indicating whether a discount is offered, a discount value, a discount type, and QoS adjustments allowed.

7. A non-transitory computer-readable medium having stored thereon instructions that, when executed by a processor, cause the processor to:
provide a set of cloud-based computational services utilizing a plurality of resources to a requesting entity, wherein the computational services are provided by an infrastructure environment having an infrastructure management agent to at least manage parameters corresponding to selected computational services;
perform a revenue accounting corresponding to a first time period for the requesting entity based on computational services utilized by the requesting entity;
adjust quality of service (QoS) parameters, with the infrastructure management agent, for the cloud-based computational services based on the revenue accounting if the revenue has changed over the first period of time;
modify billing discounts for current cloud-based computational services, with the infrastructure management agent, if the revenue has changed over the first period of time; and
provide the set of cloud-based computational services to the requesting entity according to the adjustment of the QoS parameters and according to the modified billing discounts over a second period of time.

8. The non-transitory computer-readable medium of claim 7 further comprising instructions that, when executed, cause the processor to modify future billing discounts for the cloud-based computational services, with the infrastructure management agent, if the revenue has changed over the first period of time, QoS adjustment is not allowed and modification of billing discounts for future cloud-based computational services is allowed.

9. The non-transitory computer-readable medium of claim 7 wherein modifying billing discounts for current cloud-based computational services comprises modifying resource billing where a discounted price is inversely proportional to a speed of revenue generation.

10. The non-transitory computer-readable medium of claim 7 wherein determining if revenue has changed over the first period of time beyond pre-selected threshold amounts comprises:
determining a rate of revenue change over the first period of time;
comparing the rate of revenue change to a pre-selected upper rate of change and to a pre-selected lower rate of change.

11. The non-transitory computer-readable medium of claim 7 further comprising instructions that, when executed, cause the processor to analyze provider parameters for services being accessed, the provider parameters indicating at least whether QoS adjustment is allowed, whether QoS adjustment is allowed and whether modification of billing discounts for future cloud-based computational services is allowed.

12. The non-transitory computer-readable medium of claim 7 further comprising instructions that, when executed, cause the processor to analyze provider parameters from infrastructure providers providing the cloud-based computational services, the provider parameters corresponding to the cloud-based computational services and indicating whether a discount is offered, a discount value, a discount type, and QoS adjustments allowed.

13. The non-transitory computer-readable medium of claim 7 wherein QoS adjustment comprises at least modifications to one or more of: allowed throughput, allowed delay, security level, privacy level, priority level and resource availability.

14. A method comprising:
providing a set of cloud-based computational services utilizing a plurality of resources to a requesting entity, wherein the computational services are provided by an infrastructure environment having an infrastructure management agent to at least manage parameters corresponding to selected computational services;
performing a revenue accounting corresponding to a first time period for the requesting entity based on computational services utilized by the requesting entity;
adjusting quality of service (QoS) parameters, with the infrastructure management agent, for the cloud-based computational services based on the revenue accounting if the revenue has changed over the first period of time;
modifying billing discounts for current cloud-based computational services, with the infrastructure management agent, if the revenue has changed over the first period of time; and
providing the set of cloud-based computational services to the requesting entity according to the adjustment of the QoS parameters and according to the modified billing discounts over a second period of time.

15. The method of claim 14 further comprising modifying future billing discounts for the cloud-based computational services, with the infrastructure management agent, if the revenue has changed over the first period of time and modification of billing discounts for future cloud-based computational services is allowed.

16. The method of claim 14 wherein modifying billing discounts for current cloud-based computational services comprises modifying resource billing where a discounted price is inversely proportional to a speed of revenue generation.

17. The method of claim 14 wherein determining if revenue has changed over the first period of time comprises:
determining a rate of revenue change over the first period of time;
comparing the rate of revenue change to a pre-selected upper rate of change and to a pre-selected lower rate of change.

18. The method of claim 14 further comprising analyzing provider parameters for services being accessed, the provider parameters indicating at least whether QoS adjustment is allowed, whether QoS adjustment is allowed and whether modification of billing discounts for future cloud-based computational services is allowed.

19. The method of claim 18 further comprising analyzing provider parameters from infrastructure providers providing the cloud-based computational services, the provider parameters corresponding to the cloud-based computational services and indicating whether a discount is offered, a discount value, a discount type, and QoS adjustments allowed.

20. The method of claim 14 wherein QoS adjustment comprises at least modifications to one or more of: allowed throughput, allowed delay, security level, privacy level, priority level and resource availability.
